(19) United States
(12) Patent Application Publication
(10) Pub. No.: US 2024/0034899 A1
(43) Pub. Date: Feb. 1, 2024

(54) CURABLE COMPOSITION

(71) Applicant: TOKYO OHKA KOGYO CO., LTD., Kawasaki-shi (JP)

(72) Inventors: Isao HIRANO, Kanagawa (JP); Yohei AOYAMA, Kawasaki-shi (JP)

(21) Appl. No.: 18/339,644

(22) Filed: Jun. 22, 2023

(30) Foreign Application Priority Data
Jul. 27, 2022 (JP) 2022-119432

(51) Int. Cl. C09D 11/38; C09D 11/101; C09D 11/102; B41J 11/00; B41M 7/00

(52) U.S. Cl. CPC C09D 11/38; C09D 11/101; C09D 11/102; B41J 11/00214; B41M 7/0081

(57) ABSTRACT

Provided are a curable composition curing well and having a good film formation ability with an inkjet coating, a cured product of the curable composition, and a method for forming a cured film using the curable composition. The curable composition contains a polyfunctional vinyl ether compound (A), a polyfunctional thiol compound (B), a curing agent (C), a photosensitizing agent (D), and stabilizing agent (E). In the curable composition, a photoradical initiator (C1) and a photoacid generator (C2) are used as the curing agent (C), a carbazole compound is used as the photosensitizing agent (D), and an imidazole compound is used as the stabilizing agent (E).

### BACKGROUND OF THE INVENTION

### Field of the Invention

The present invention relates to a curable composition, a cured product of the curable composition, and a method for forming a cured film using the curable composition.

### Related Art

Conventionally, a surface of a material such as a resin plate, a glass plate, or a metal plate is provided with a coating layer for the purpose of surface protection. Various studies have been conducted on a curable composition to form such a coating layer.

For example, in order to form a coating layer for protecting a recording film of an optical disk, a UV-curable resin composition containing a cationic polymerizable substance and a photocationic initiator and capable of being applied to an inkjet printing method has been proposed (see Patent Document 1). When the UV-curable resin composition described in Patent Document 1 is used, a well-cured coating layer can be formed from a small amount of the UV-curable resin composition by exposing a coating film formed by an inkjet method to UV light.

Patent Document 1: Japanese Unexamined Patent Application, Publication No. H09-183928

### SUMMARY OF THE INVENTION

However, a curable composition containing a cationic polymerizable substance and a photocationic initiator may thicken upon storage for a long period of time. In other words, the curable composition containing a cationic polymerizable substance and a photocationic initiator does not always have good storage stability.

The present invention has been made in view of the above-mentioned problem, and an object thereof is to provide a curable composition curing well and having a good film formation ability with an inkjet coating, a cured product of the curable composition, and a method for forming a cured film using the curable composition.

The present inventors have found that the above-mentioned problem can be solved by a curable composition containing a polyfunctional vinyl ether compound (A), a polyfunctional thiol compound (B), a curing agent (C), a photosensitizing agent (D), and stabilizing agent (E), the curing agent (C) being a photoradical initiator (C1) and a photoacid generator (C2), the photosensitizing agent (D) being a carbazole compound, and the stabilizing agent (E) being an imidazole compound. Thus, the present invention has been completed. More specifically, the present invention provides the following aspects.

A first aspect of the present invention relates to a curable composition including:
a polyfunctional vinyl ether compound (A);
a polyfunctional thiol compound (B);
a curing agent (C);
a photosensitizing agent (D); and
a stabilizing agent (E),
the curing agent (C) including a photoradical initiator (C1) and a photoacid generator (C2),
the photosensitizing agent (D) including a carbazole compound, and
the stabilizing agent (E) including an imidazole compound.

A second aspect of the present invention relates to a cured product of the curable composition according to the first aspect.

A third aspect of the present invention relates to a method for forming a coated film, the method including: coating a substrate with the curable composition according to the first aspect to form a coated film;
exposing the coated film; and
heating the coated film having been exposed.

The present invention can provide a curable composition curing well and having a good film formation ability with an inkjet coating, a cured product of the curable composition, and a method for forming a cured film using the curable composition.

### DETAILED DESCRIPTION OF THE INVENTION

### <<Curable Composition>>

A curable composition includes a polyfunctional vinyl ether compound (A); a polyfunctional thiol compound (B); a curing agent (C); a photosensitizing agent (D); and a stabilizing agent (E). The curing agent (C) includes a photoradical initiator (C1) and a photoacid generator (C2). The photosensitizing agent (D) includes a carbazole compound. The stabilizing agent (E) includes an imidazole compound. The above-mentioned curable composition cures well and has a good film formation ability with an inkjet coating. Essential or optional components included in the curable composition will be described.

### <Polyfunctional Vinyl Ether Compound (A)>

The curable composition includes a polyfunctional vinyl ether compound (A) as a curable compound. When the curable composition is exposed, the photoradical initiator (C1) generates a radical to cause a thiol-en reaction between the polyfunctional vinyl ether compound (A) and the polyfunctional thiol compound (B). Moreover, when the curable composition is exposed, cationic polymerization of the polyfunctional vinyl ether (A) proceeds under action of an acid generated by the photoacid generator (C2). The above-mentioned reaction allows the curable composition to cure well.

The polyfunctional vinyl ether compound (A) is a compound having two or more vinyloxy groups. A divalent or higher-valent organic group serving as a core to which the vinyloxy groups bind may be a hydrocarbon group or an organic group including a heteroatom. Examples of the heteroatom include 0, S, N, P, a halogen atom, and the like.

The divalent or higher-valent organic group serving as the core to which the vinyloxy groups bind in the polyfunctional vinyl ether compound (A) is preferably a hydrocarbon group from the viewpoints of chemical stability and good solubility in the curable composition. The hydrocarbon group may be an aliphatic hydrocarbon group, an aromatic hydrocarbon group, or a combination of an aliphatic hydrocarbon group and an aromatic hydrocarbon group, with the aliphatic hydrocarbon group being preferred.

When the divalent or higher-valent organic group serving as the core to which the vinyloxy groups bind in the polyfunctional vinyl ether compound (A) is a hydrocarbon group, a number of carbon atoms in the hydrocarbon group is not particularly limited unless the object of the present invention is impaired. The number of carbon atoms is, for example, preferably 1 or more and 40 or less, more preferably 2 or more and 20 or less, and further preferably 2 or more and 10 or less.

A number of the vinyloxy group contained in the polyfunctional vinyl ether compound (A) is not particularly limited. The number of the vinyloxy group is preferably 2 or more and 6 or less, more preferably 2 or more and 4 or less, and particularly preferably 2 or 3 per one molecule.

Specific examples of the polyfunctional vinyl ether compound (A) include a chain aliphatic divinyl ether such as ethylene glycol divinyl ether, diethylene glycol divinyl ether, triethylene glycol divinyl ether, polyethylene glycol divinyl ether, propylene glycol divinyl ether, dipropylene glycol divinyl ether, tripropylene glycol divinyl ether, polypropylene glycol divinyl ether, 1,3-propanediol divinyl ether, 1,4-butanediol divinyl ether, 1,5-pentanediol divinyl ether, 1,6-hexanediol divinyl ether, 1,8-octanediol divinyl ether, 1,10-decanediol divinyl ether, neopentyl glycol divinyl ether, trimethylolpropane divinyl ether, and pentaerythritol divinyl ether; a cyclic aliphatic divinyl ether such as 1,4-cyclohexanediol divinyl ether, 1,4-cyclohexanedimethanol divinyl ether (CHDVE), and 2-vinyloxy-5-(vinyloxymethyl)-7-oxabicyclo[2.2.1]heptane; an aromatic divinyl ether such as 1,4-divinyloxybenzene, 1,3-divinyloxybenzene, 1,2-divinyloxybenzene, 1,4-divinyloxynaphthalene, 1,3-divinyloxynaphthalene, 1,2-divinyloxynaphthalene, 1,5-divinyloxynaphthalene, 1,6-divinyloxynaphthalene, 1,7-divinyloxynaphthalene, 1,8-divinyloxynaphthalene, 2,3-divinyloxynaphthalene, 2,6-divinyloxynaphthalene, 2,7-divinyloxynaphthalene, 4,4′-divinyloxybiphenyl, 3,3′-divinyloxybiphenyl, 2,2′-divinyloxybiphenyl, 3,4′-divinyloxybiphenyl, 2,3′-divinyloxybiphenyl, 2,4′-divinyloxybiphenyl, bisphenol A divinyl ether, 1,4-benzenedimethanol divinyl ether, 1,3-benzenedimethanol divinyl ether, 1,2-benzenedimethanol divinyl ether, and naphthalen-1,4-bismethanol divinyl ether; and a trivalent or higher-valnet polyvalent vinyl ether such as trimethylolpropane trivinyl ether, pentaerythritol tetravinyl ether, sorbitol tetravinyl ether, sorbitol pentavinyl ether, dipentaerythritol pentavinyl ether, and dipentaerythritol hexavinyl ether.

Among the above-mentioned polyfunctional vinyl ether compounds (A), the cyclic aliphatic divinyl ether such as 1,4-cyclohexanediol divinyl ether, 1,4-cyclohexanedimethanol divinyl ether (CHDVE), and 2-vinyloxy-5-(vinyloxymethyl)-7-oxabicyclo[2.2.1]heptane is preferred and 1,4-cyclohexanedimethanol divinyl ether (CHDVE) is more preferred from the viewpoints of excellent curability and easiness of forming a cured product having excellent various mechanical properties, optical properties such as transparency, chemical resistance, and heat resistance. The cyclic aliphatic divinyl ether is an aliphatic divinyl ether compound being alicyclic and having no aromatic group.

An amount of the polyfunctional divinyl ether compound (A) used in the curable composition is not particularly limited unless a desired effect is impaired. From the viewpoint of curability of the curable composition, the amount of the polyfunctional divinyl ether compound (A) is preferably 50% by mass or more and 99% by mass or less, more preferably 70% by mass or more and 98% by mass or less, and further preferably 80% by mass or more and 95% by mass or less relative to a total mass of the polyfunctional divinyl ether compound (A) and the polyfunctional thiol compound (B). A proportion of the total mass of the polyfunctional divinyl ether compound (A) and the polyfunctional thiol compound (B) relative to a mass of the curable composition is preferably 50% by mass or more and 99% by mass or less, more preferably 70% by mass or more and 98% by mass or less, and further preferably 80% by mass or more and 95% by mass or less.

### <Polyfunctional Thiol Compound (B)>

The curable composition includes a polyfunctional thiol compound (B). A number of a mercapto group contained in the polyfunctional thiol compound (B) is 2 or more, preferably 2 or more and 10 or less, and more preferably 2 or more and 6 or less.

Specific examples of the polyfunctional thiol compound (B) include 1,2-benzenedithiol, 1,3-benzenedithiol, 1,4-benzenedithiol, 1,2-bis(mercaptomethyl)benzene, 1,3-bis(mercaptomethyl)benzene, 1,4-bis(mercaptomethyl)benzene, 1,2-bis(mercaptoethyl)benzene, 1,3-bis(mercaptoethyl)benzene, 1,4-bis(mercaptoethyl)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,2,4-tris(mercaptoethyl)benzene, 1,3,5-tris(mercaptoethyl)benzene, 2,5-toluenedithiol, 3,4-toluenedithiol, 1,3-di(p-methoxyphenyl)propan-2,2-dithiol, 1,3-diphenylpropan-2,2-dithiol, phenylmethan-1,1-dithiol, 2,4-di(p-mercaptophenyl)pentane, 1,2-bis(mercaptoethylthio)benzene, 1,3-bis(mercaptoethylthio)benzene, 1,4-bis(mercaptoethylthio)benzene, 1,2,3-tris(mercaptomethylthio)benzene, 1,2,4-tris(mercaptomethylthio)benzene, 1,3,5-tris(mercaptomethylthio)benzene, 1,2,3-tris(mercaptoethylthio)benzene, 1,2,4-tris(mercaptoethylthio)benzene, and 1,3,5-tris(mercaptoethylthio)benzene.

Moreover, the polyfunctional thiol compound (B) is preferably mercaptoalkanoate of polyol having two or more hydroxy groups from the viewpoints of easiness of availability and synthesis, and dissolution stability in the curable composition. The mercaptoalkanoate of polyol having two or more hydroxy groups may have a hydroxy group, but preferably does not have a hydroxy group.

A number of carbon atoms contained in a mercaptoalkanoic acid giving mercaptoalkanoate is not particularly limited, but is preferably 2 or more and 6 or less and more preferably 3 or 4. Specific examples of the mercaptoalkanoic acid giving mercaptoalkanoate include thioglycolic acid, 2-mercaptopropionic acid, 3-mercaptopropionic acid, 2-mercaptobutanoic acid, 3-mercaptobutanoic acid, 4-mercaptobutanoic acid, 2-mercaptopentanoic acid, 3-mercaptopentanoic acid, 4-mercaptopentanoic acid, 5-mercaptopentanoic acid, 2-mercaptohexanoic acid, 3-mercaptohexanoic acid, 4-mercaptohexanoic acid, and 5-mercaptohexanoic acid. Among them, 2-mercaptopropionic acid and 3-mercaptobutanoic acid are preferred.

A polyol giving mercaptoalkanoate may include an aromatic group. Examples of polyol including no aromatic group include ethylene glycol, 1,3-propanediol, propylene glycol, 1,4-butanediol, 1,5-pentanediol, 1,6-hexanediol, 1,7-heptanediol, 1,8-octanediol, 1,9-nonanediol, 1,10-decanediol, diethylene glycol, triethylene glycol, tetraethylene glycol, dipropylene glycol, tripropylene glycol, tetrapropylene glycol, 1,4-cyclohexanediol, 1,3-cyclohexanediol, 1,2-cyclohexanediol, 1,4-cyclohexanedimethanol, hydrogenated bisphenol A, glycerin, diglycerin, triglycerin, trimethylolethane, trimethylolpropane, pentaerythritol, dipentaerythritol, sorbitol, mannitol, sorbitan, sucrose, glucose, mannose, methylglcoside, and tris(2-hydroxyethyl)isocyanurate. Examples of aromatic polyol include benzenediol such as hydroquinone, resorcinol, and catechol; benzenetriol such as phloroglucinol, pyrogallol, and 1,2,4-benzenetriol; naphthalenediol such as 1,2-naphthalenediol, 1,3-naphthalenediol, 1,4-naphthalenediol, 1,5-naphthalenediol, 1,6-naphthalenediol, 1,7-naphthalenediol, 1,5-naphthalenediol, 2,3-naphthalenediol, 2,6-naphthalenediol, and 2,7-naphthalene diol; naphthalenetriol such as 1,4,5-naphthalenetriol, 1,2,4-naphthalenetriol, 1,3,8-naphthalenetriol, and 1,2,7-naphthalenetriol; bisphenol such as bisphenol A, bisphenol AP, bisphenol AF, bisphenol B, bisphenol BP, bisphenol C, bisphenol E, bisphenol F, bisphenol S, and bisphenol Z; tetrahydroxybiphenyl such as 3,3′,4,4′-tetrahydroxybiphenyl and 3,3′,5,5′-tetrahydroxybiphenyl; calixarene; and a novolak resin such as phenol novolak, cresol novolak, and naphthol novolak.

Among the above-mentioned polyols, ethylene glycol, 1,3-propanediol, propylene glycol, 1,4-butanediol, 1,5-pentanediol, 1,6-hexanediol, diethylene glycol, dipropylene glycol, glycerin, diglycerin, trimethylolethane, trimethylolpropane, pentaerythritol, dipentaerythritol, and tris(2-hydroxyethyl)isocyanurate are preferred, and 1,4-butanediol, trimethylolethane, trimethylolpropane, pentaerythritol, and tris(2-hydroxyethyl)isocyanurate are more preferred.

Mercaptoalkanoate of the above-described polyol is preferably 1,4-butanediol di(2-mercaptopropionate), 1,4-butanediol di(3-mercaptobutanoate), trimethylolethane tri(2-mercaptopropionate), trimethylolethane tri(3-mercaptobutanoate), trimethylolpropane tri(2-mercaptopropionate), trimethylolpropane tri(3-mercaptobutanoate), pentaerythritol tetra(2-mercaptopropionate), pentaerythritol tetra(3-mercaptobutanoate), tris(2-hydroxyethyl)isocyanurate tri(2-mercaptopropionate), and tris(2-hydroxyethyl)isocyanurate tri(3-mercaptobutanoate), and more preferably 1,4-butanediol di(3-mercaptobutanoate), trimethylolethane tri(3-mercaptobutanoate), trimethylolpropane tri(3-mercaptobutanoate), pentaerythritol tetra(3-mercaptobutanoate), and tris(2-hydroxyethyl)isocyanurate tri(3-mercaptobutanoate).

An amount of the polyfunctional thiol compound (B) used is preferably 1% by mass or more and 50% by mass or less, more preferably 2% by mass or more and 30% by mass or less, and further preferably 5% by mass or more and 20% by mass or less relative to a total mass of the polyfunctional divinyl ether compound (A) and the polyfunctional thiol compound (B) from the viewpoint of curability of the curable composition.

### <Curing Agent (C)>

A curing agent (C) is a component allowing the polyfunctional vinyl ether compound (A) to react with the polyfunctional thiol compound (B) upon exposure to thereby cure the curable composition. The curing agent (C) includes a photoradical initiator (C1) and a photoacid generator (C2). The photoradical initiator (C1) and the photoacid generator (C2) will be described.

### [Photoradical Initiator (C1)]

Various compounds that have conventionally been used as a photoradical initiator for a radical polymerization of radical polymerizable compound may be used without limitation as the photoradical initiator (C1).

Specific examples of the photoradical initiator (C1) include an alkylphenone photopolymerization initiator such as Omnirad 651, Omnirad 184, Omnirad 1173, Omnirad 2959, Omnirad 127, Omnirad 907, Omnirad 369, Omnirad 369E, and Omnirad 379EG (all from IGM Resins B.V.), an acylphosphine oxide photopolymerization initiator such as Omnirad TPO H and Omnirad 819 (all from IGM Resins B.V.), and an oxime ester photopolymerization initiator such as Irgacure OXE01 and Irgacure OXE02 (all from BASF). Among them, an alkylphenone photopolymerization initiator is preferred and Omnirad 651 (2,2-dimethoxy-2-phenylacetophenone) is more preferred from the viewpoint of compatibility with the polyfunctional vinyl ether compound (A) or the polyfunctional thiol compound.

Specific examples of the photoradical initiator (C1) include 1-hydroxycyclohexyl phenyl ketone, 2-hydroxy-2-methyl-1-phenylpropan-1-one, 1-[4-(2-hydroxyethoxy)phenyl]-2-hydroxy-2-methyl-1-propan-1-one, 1-(4-isopropylphenyl)-2-hydroxy-2-methylpropan-1-one, 1-(4-dodecylphenyl)-2-hydroxy-2-methylpropan-1-one, 2,2-dimethoxy-1,2-diphenylethan-1-one, bis(4-dimethylaminophenyl)ketone, 2-methyl-1-[4-(methylthio)phenyl]-2-morpholinopropan-1-one, 2-benzyl-2-dimethylamino-1-(4-morpholinophenyl)-butan-1-one, 1,2-octanedione, 1-[4-(phenylthio)phenyl]-, 2-(O-benzoyloxime) (Irgacure OXE01), ethanon-1-[9-ethyl-6-(2-methylbenzoyl)-9H-carbazol-3-yl]-1-(0-acetyloxime) (Irgacure OXE02), 2,4,6-trimethylbenzoyl diphenylphosphine oxide (Omnirad TPO H), bis(2,4,6-trimethylbenzoyl)phenylphosphineoxide (Omnirad 819), 4-benzoyl-4′-methyldimethylsulfide, 4-dimethylaminobenzoic acid, methyl 4-dimethylaminobenzoate, ethyl 4-dimethylaminobenzoate, butyl 4-dimethylaminobenzoate, 4-dimethylamino-2-ethylhexylbenzoic acid, 4-dimethylamino-2-isoamylbenzoic acid, benzyl-β-methoxyethyl acetal, benzyldimethyl ketal, 1-phenyl-1,2-propanedion-2-(0-ethoxycarbonyl)oxime, methyl O-benzoylbenzoate, 2,4-diethylthioxanthone, 2-chlorothioxanthone, 2,4-dimethylthioxanthone, 1-chloro-4-propoxythioxanthone, thioxanthene, 2-chlorothioxanthene, 2,4-diethylthioxanthene, 2-methylthioxanthene, 2-isopropylthioxanthene, 2-ethylanthraquinone, octamethylanthraquinone, 1,2-benzanthraquinone, 2,3-diphenylanthraquinone, azobisisobutyronitrile, benzoylperoxide, cumene hydroperoxide, 2-mercaptobenzoimidale, 2-mercaptobenzooxazole, 2-mercaptobenzothiazole, a 2-(0-chlorophenyl)-4,5-di(m-methoxyphenyl)-imidazolyl dimer, benzophenone, 2-chlorobenzophenone, p,p′-bisdimethylaminobenzophenone, 4,4′-bisdiethylaminobenzophenone, 4,4′-dichlorobenzophenone, 3,3-dimethyl-4-methoxybenzophenone, benzyl, benzoin, benzoin methyl ether, benzoin ethyl ether, benzoin isopropyl ether, benzoin-n-butyl ether, benzoin isobutyl ether, benzoin butyl ether, acetophenone, 2,2-diethoxyacetophenone, p-dimethylacetophenone, p-dimethylaminopropiophenone, dichloroacetophenone, trichloroacetophenone, p-tert-butylacetophenone, p-dimethylaminoacetophenone, p-tert-butyltrichloroacetophenone, p-tert-butyldichloroacetophenone, α,α-dichloro-4-phenoxyacetophenone, thioxanthone, 2-methylthioxanthone, 2-isopropylthioxanthone, dibenzosuberone, pentyl-4-dimethylaminobenzoate, 9-phenylacridine, 1,7-bis-(9-acridinyl)heptane, 1,5-bis-(9-acridinyl)pentane, 1,3-bis-(9-acridinyl) propane, p-methoxytriazine, 2,4,6-tris(trichloromethyl)-s-triazine, 2-methyl-4,6-bis(trichloromethyl)-s-triazine, 2-[2-(5-methylfuran-2-yl)ethenyl]-4,6-bis(trichloromethyl)-s-triazine, 2-[2-(furan-2-yl)ethenyl]-4,6-bis(trichloromethyl)-s-triazine, 2-[2-(4-diethylamino-2-methylphenyl)ethenyl]-4,6-bis(trichloromethyl)-s-triazine, 2-[2-(3,4-dimethoxyphenyl)ethenyl]-4,6-bis(trichloromethyl)-s-triazine, 2-(4-methoxyphenyl)-4,6-bis(trichloromethyl)-s-triazine, 2-(4-ethoxystyryl)-4,6-bis(trichloromethyl)-s-triazine, 2-(4-n-butoxyphenyl)-4,6-bis(trichloromethyl)-s-triazine, 2,4-bis-trichloromethyl-6-(3-bromo-4-methoxy)phenyl-s-triazine, 2,4-bis-trichloromethyl-6-(2-bromo-4-methoxy)phenyl-s-triazine, 2,4-bis-trichloromethyl-6-(3-bromo-4-methoxy)styrylphenyl-s-triazine, and 2,4-bis-trichloromethyl-6-(2-bromo-4-methoxy)styrylphenyl-s-triazine. The photoradical initiator (C1) may be used alone or in combination of two or more.

An amount of the photoradical initiator (C1) contained in the curable composition is preferably 0.1% by mass or more and 10% by mass or less, more preferably 0.2% by mass or more and 7% by mass or less, and further preferably 0.5% by mass or more and 5% by mass or less relative to a total mass of the polyfunctional vinyl ether compound (A) and the polyfunctional thiol compound (B).

### [Photoacid Generator (C2)]

The photoacid generator (C2) is not particularly limited as long as it allows the above-mentioned polyfunctional vinyl ether compound (A) to cationically polymerize. Examples of the photoacid generator (C2) include various known photoacid generators, for example, an onium salt such as an iodonium salt and a sulfonium salt, an oxime sulfonate compound, a diazomethane compound, a nitrobenzyl sulfonate compound, an iminosulfonate compound, and a disulfone compound. Among the photoacid generator, a diazomethane compound is preferred from the viewpoint of easiness of uniformly mixing into the curable composition.

Examples of the diazomethane compound include bis(alkylsulfonyl)diazomethane, bis(cycloalkylsulfonyl)diazomethane, and bis(arylsulfonyl)diazomethane. Specific examples of the diazomethane compound include bis(isopropylsulfonyl)diazomethane, bis(tert-butylsulfonyl) diazomethane, bis(p-toluenesulfonyl)diazomethane, bis(1,1-dimethylethylsulfonyl)diazomethane, bis(cyclohexylsulfonyl)diazomethane, and bis(2,4-dimethylphenylsulfonyl)diazomethane.

Poly(bissulfonyl)diazomethane may also be used as the diazomethane compound. Examples of poly(bissulfonyl)diazomethane include 1,3-bis(phenylsulfonyldiazomethylsulfonyl)propane, 1,4-bis(phenylsulfonyldiazomethylsulfonyl)butane, 1,6-bis(phenylsulfonyldiazomethylsulfonyl)hexane, 1,10-bis(phenylsulfonyldiazomethylsulfonyl)decane, 1,2-bis(cyclohexylsulfonyldiazomethylsulfonyl)ethane, 1,3-bis(cyclohexylsulfonyldiazomethylsulfonyl)propane, 1,6-bis(cyclohexylsulfonyldiazomethylsulfonyl)hexane, and 1,10-bis(cyclohexylsulfonyldiazomethylsulfonyl)decane.

An amount of the diazomethane compound contained in the photoacid generator (C2) is not particularly limited unless a desired effect is impaired. The amount of the diazomethane compound contained in the photoacid generator (C2) is preferably 50% by mass or more, more preferably 70% by mass or more, further preferably 80% by mass or more, further more preferably 90% by mass, and particularly preferably 100% by mass relative to a mass of the photoacid generator (C2).

An amount of the photoacid generator (C2) contained in the curable composition is preferably 0.1% by mass or more and 10% by mass or less, more preferably 0.2% by mass or more and 7% by mass or less, and further preferably 0.5% by mass or more and 5% by mass or less relative to a total mass of the polyfunctional vinyl ether compound (A) and the polyfunctional thiol compound (B).

### <Photosensitizing Agent (D)>

The curable composition includes a photosensitizing agent (D). The photosensitizing agent (D) is a component sensitizing the photoacid generator (C2), in particular, the diazomethane compound. The photosensitizing agent (D) includes a carbazole compound. A curable composition including the photosensitizing agent (D) cures well and has good storage stability.

The carbazole compound is not particularly limited unless a desired effect is impaired. The carbazole compound is preferably carbazole or N-alkyl carbazole. A number of carbon atoms contained in an alkyl group in the N-alkyl carbazole is preferably 1 or more and 8 or less and more preferably 1 or more and 6 or less. Specific examples of the N-alkyl carbazole include N-methyl carbazole, N-ethyl carbazole, N-n-propyl carbazole, N-isopropyl carbazole, N-n-butyl carbazole, N-isobutyl carbazole, N-sec-butyl carbazole, N-tert-butyl carbazole, and N-n-hexyl carbazole.

The photosensitizing agent (D) may include, in addition to the carbazole compound, other sensitizing agents that have conventionally been used with various photoacid generators. Specific examples of the other sensitizing agents include an anthracene compound such as anthracene, 9,10-dibutoxyanthracene, 9,10-dimethoxyanthracene, 9,10-diethoxyanthracene, 2-ethyl-9,10-dimethoxyanthracene, and 9,10-dipropoxyanthracene; pyrene; 1,2-benzanthracene; perylene; tetracene; coronene; a thioxanthone compound such as thioxanthone, 2-methylthioxanthone, 2-ethylthioxanthone, 2-chlorothioxanthone, 2-isopropylthioxanthone, and 2,4-diethylthioxanthone; a phenothiazine compound such as phenothiazine, N-methylphenothiazine, N-ethylphenothiazine, and N-phenylphenothiazine; xanthone; a naphthalene compound such as 1-naphthol, 2-naphthol, 1-methoxynaphthalene, 2-methoxynaphthalene, 1,4-dihydroxynaphthalene, and 4-methoxy-1-naphthol; ketone such as dimethoxyacetophenone, diethoxyacetophenone, 2-hydroxy-2-methyl-1-phenylpropan-1-one, 4′-isopropyl-2-hydroxy-2-methylpropiophenone, and 4-benzoyl-4′-methyldiphenylsulfide; a chrysene compound such as 1,4-dimethoxychrysene and 1,4-di-α-methylbenzyloxychrysene; a phenanthrene compound such as 9-hydroxyphenanthrene, 9-methoxyphenanthrene, 9-hydroxy-10-methoxyphenanthrene, and 9-hydroxy-10-ethoxyphenanthrene.

A mass proportion of the carbazole compound to the photosensitizing agent (D) is preferably 50% by mass or more, more preferably 70% by mass or more, further preferably 80% by mass or more, further more preferably 90% by mass, and particularly preferably 100% by mass.

An amount of the photosensitizing agent (D) contained in the curable composition is preferably 0.1% by mass or more and 10% by mass or less, more preferably 0.2% by mass or more and 5% by mass or less, and further preferably 0.5% by mass or more and 3% by mass or less relative to a total mass of the polyfunctional vinyl ether compound (A) and the polyfunctional thiol compound (B).

### <Stabilizing Agent (E)>

The curable composition includes an imidazole compound as a stabilizing agent (E). A curable composition including the imidazole compound as the stabilizing agent (E) has good storage stability.

The imidazole compound is not particularly limited as long as it has an imidazole backbone. Examples of a compound having an imidazole backbone include imidazole, imidazole having a substituent, and a fused ring compound including an imidazole ring and another ring fused with each other.

Specific examples of the imidazole compound include imidazole, 1-methylimidazole, 2-methylimidazole, 4-methylimidazole, 1,2-dimethylpyrazole, 2-ethyl-4-methylimidazole, 2-isopropylimidazole, benzoimidazole, 5,6-dimethylbenzoimidazole, 2-aminobenzoimidazole, 2-chlorobenzoimidazole, 2-methylbenzoimidazole, 2-(1-hydroxyethyl)benzimidazole, 2-hydroxybenzimidazole, 2-phenylbenzimidazole, 2,5-dimethylbenzimidazole, 5-methylbenzoimidazole, 5-nitrobenzimidazole, and 1H-purine.

Moreover, an imidazole compound having one or more radical polymerizable groups is also preferred as the imidazole compound. As the radical polymerizable group, a group having an ethylenically unsaturated double bond is preferred. The radical polymerizable groups are typically selected from an alkenyl group, an acryloyl-containing group, and a methacryloyl-containing group. Specific examples of the imidazole compound having one or more radical polymerizable groups include 1-alkenylimidazole such as 1-vinylimidazole, 1-allylimidazole, 1-(3-butenyl)imidazole, 1-(4-pentenyl)imidazole, and 1-(5-hexenyl)imidazole.

An amount of the imidazole compound contained in the curable composition is preferably 0.1% by mass or more and 10% by mass or less, more preferably 0.2% by mass or more and 8% by mass or less, and further preferably 0.5% by mass or more and 6% by mass or less relative to a total mass of the polyfunctional vinyl ether compound (A) and the polyfunctional thiol compound (B).

### <Solvent (S)>

The curable composition may include a solvent (S) as necessary. However, the curable composition preferably includes no or only a small amount of the solvent (S) from the viewpoint of preventing the viscosity of the curable composition from changing over time. Specifically, a mass proportion of the solvent (S) to the curable composition is preferably 0% by mass or more and 5% by mass or less, more preferably 0% by mass or more and 3% by mass or less, and further preferably 0% by mass or more and 1% by mass or less. Various solvents that have conventionally been incorporated into the curable composition may be used as the solvent (S). The solvent (S) is preferably an organic solvent.

### <Other Components>

The curable composition may contain various additives other than the above-described components as necessary. Examples of the additives include a coloring agent, a dispersing agent, an adhesion promoting agent, a polymerization inhibiting agent, an antioxidizing agent, a UV absorbing agent, an aggregation inhibiting agent, an antifoaming agent, a surface-active agent, and a silane coupling agent. Moreover, the curable composition may include various filling materials or reinforcement materials as necessary. Amounts of the various additives are not particularly limited unless the object of the present invention is impaired.

The above-described curable composition has good storage stability. Specifically, an absolute difference between an initial viscosity of the curable composition immediately after preparation as measured by an E-type viscometer at 20° C. and a post-storage viscosity of the curable composition stored for 2 weeks at 20° C. after preparation as measured by an E-type viscometer at 20° C. is 5 cP or less. The absolute difference between the initial viscosity and the post-storage viscosity is preferably 3 cP or less, more preferably 2 cP or less, and particularly preferably 1 cP or less. Thus, the above-mentioned curable composition exhibits a stable viscosity for a long period of time. Therefore, the above-mentioned curable composition is less likely to be thickened or solidified within a head in an inkjet printer. Consequently, the above-mentioned curable composition is suitably used for an inkjet printing method.

### <Method for Producing Curable Composition>

A curable composition is prepared by uniformly mixing the above-mentioned components in desired amounts with stirring. A device for mixing the above-mentioned components with stirring may be a dissolver, a homogenizer, and a three-roll mill. After the above-mentioned components are uniformly mixed, the resulting mixture may be filtered through, for example, a mesh or a membrane filter.

### <<Method for Forming Cured Film>>

The above-described curable composition can be used to form a cured film. Specifically, the cured film is formed by a method including coating a substrate with the above-mentioned curable composition to form a coated film;
exposing the coated film; and
heating the coated film having been exposed.

First, a desired substrate is coated with the above-mentioned curable composition to form a coated film. Then, at least a portion of a solvent (S) is removed from the coated film as necessary to form a coated film.

A method for coating the substrate with the curable composition is not particularly limited. For example, a contact transfer coating device such as a roll coater, a reverse coater, a bar coater, and a slit coater, a spinner (rotating coating device), or a non-contact coating device such as a curtain flow coater can be used to coat a substrate with the curable composition so as to give a desired film thickness to form a coated film. A printing method such as a screen-printing method or an inkjet printing method may also be applied for forming a coated film. As mentioned above, the curable composition may be suitably used for an inkjet printing method.

After the coated film is formed by the above-mentioned method, the coated film is exposed to allow curing of the coated film to proceed.

A condition under which the coated film is exposed is not particularly limited as long as curing proceeds well. The coated film is exposed by, for example, irradiation with an active energy ray such as UV or excimer laser beam. An energy dose with which the coated film is irradiated is not particularly limited. For example, it may be 30 mJ/cm² or more and 5000 mJ/cm² or less. The coated film which has been exposed may be baked in the same manner as in heating after the coating.

The thus-exposed coated film is then heated. A heating condition is not particularly limited as long as the coated film can be completely cured. Whether the coated film has been completely cured or not can be determined by touching the coated film which has been heated with a finger to check the presence of tack. A heating temperature is not particularly limited. The heating temperature is, for example, 80° C. or more and 250° C. or less, more preferably 100° C. or more and 200° C. or less, and further preferably 110° C. or more and 180° C. or less. A heating time is, for example, 10 seconds or more and 1 hour or less, more preferably 20 seconds or more and 30 minutes or less, and further preferably 30 seconds or more and minutes or less.

As described above, a cured film that has been cured well can be formed.

As mentioned above, the present inventors provide (1) to (9) below.
(1) A curable composition including:
a polyfunctional vinyl ether compound (A);
a polyfunctional thiol compound (B);
a curing agent (C);
a photosensitizing agent (D); and
   a stabilizing agent (E),
in which the curing agent (C) includes a photoradical initiator (C1) and a photoacid generator (C2),
the photosensitizing agent (D) includes a carbazole compound, and
the stabilizing agent (E) includes an imidazole compound.
(2) The curable composition according to (1), in which the photoacid generator (C2) comprises a diazomethane compound.
(3) The curable composition according to (1) or (2), comprising or not comprising a solvent (S), and
in which a mass proportion of the solvent (S) to the curable composition is 0% by mass or more and 5% by mass or less.
(4) The curable composition according to any one of (1) to (3), in which the carbazole compound is carbazole or N-alkyl carbazole.
(5) The curable composition according to any one of (1) to (4), in which the imidazole compound has one or more radical polymerizable groups.
(6) The curable composition according to any one of (1) to (5), in which an absolute difference between an initial viscosity of the curable composition immediately after preparation as measured by an E-type viscometer at 20° C. and a post-storage viscosity of the curable composition stored for 2 weeks at 20° C. after preparation as measured by an E-type viscometer at 20° C. is 5 cP or less.
(7) A cured product of the curable composition according to any one of (1) to (6).
(8) A method for forming a cured film, the method including: coating a substrate with the curable composition according to any one of (1) to (6) to form a coated film;
exposing the coated film; and
heating the coated film having been exposed.
(9) A method for forming a cured film according to (8), in which the substrate is coated with the curable composition by an inkjet method.

### EXAMPLES

The present invention will be described in more detail with reference to Examples. The scope of the present invention is not limited to Examples.

### Examples 1 to 4 and Comparative Examples 1 to 6

In Examples and Comparative Examples, the following A1 was used as a polyfunctional vinyl ether compound (A). A1: 1,4-cyclohexanedimethanol divinyl ether

In Comparative Examples, the following A′1 to A′3 were used as other polymerizable compounds (A′) other than the polyfunctional vinyl ether compound (A).
A′1: Ethylene glycol diglycidyl ether (manufactured by Nagase ChemteX Corporation, DENACOL EX810)
A′2: 2-ethylhexyl glycidyl ether
A′3: 2-(2-vinyloxyethoxy) ethyl acrylate (VEEA, manufactured by NIPPON SHOKUBAI CO., LTD.)

In Examples and Comparative Examples, the following C1-1 and C1-2 were used as a photoradical initiator (C1). C1-1: 2,2-dimethoxy-2-phenylacetophenone (Omnirad 651, manufactured by IGM Resins)
C1-2: 2-methyl-1-[4-(methylthio)phenyl]-2-morpholinopropan-1-one (Omnirad 907, manufactured by IGM Resins)

In Examples and Comparative Examples, the following C2-1 to C2-4 were used as a photoacid generator (C2).
C2-1: Bis(cyclohexylsulfonyl)diazomethane (WPAG-145, manufactured by FUJIFILM Wako Pure Chemical Corporation)
C2-2: Bis(tert-butylsulfonyl)diazomethane (WPAG-170, manufactured by FUJIFILM Wako Pure Chemical Corporation)
C2-3: Diphenyl 4-thiophenoxyphenylsulfonium tris(pentafluoroethyl)trifluoro phosphate (CPI-210S, CPI-200K, manufactured by San-Apro Ltd.)
C2-4: Product name SP-606 (manufactured by ADEKA CORPORATION)

In Comparative Examples, the following C3-1 was used as a photobase generator (C3).
C3-1: 1,2-dicyclohexyl-4,4,5,5-tetramethylbiguanidium=n-butyl triphenyl borate

In Examples and Comparative Examples, the following D1 to
D3 were used as a photosensitizing agent (D).
D1: Carbazole
D2: N-ethyl carbazole
D3: Isopropylthioxanthone

In Examples and Comparative Examples, the following E1 was used as a stabilizing agent (E).
E1: 1-vinylimidazole

In Comparative Examples, the following F1 was used as another additive. The following F1 is an acid diffusion inhibiting agent.
F1: 2,6-di-tert-butylpyridine

Components in types or amounts as described in Table 1 or 2 were uniformly mixed. The resulting mixed liquids were filtered through a polyethylene filter with an opening of 1.0 μm to thereby obtain curable compositions of Examples and Comparative Examples. The resulting curable compositions were used for evaluations as described below. The evaluation results described below are summarized in Tables 1 and 2.

### <Solubility of Curing Agent (C)>

The resulting curable compositions were visually observed. According to the below-mentioned criteria, solubility of the curing agent (C) was determined by the presence or the absence of the photoradical initiator (C1), the photoacid generator (C2), or the photobase generator (C3) serving as the curing agent (C) remaining undissolved.
A: There was no undissolved curing agent (C).
B: There was an undissolved curing agent (C).

### <Inkjet Coatability>

Silicon substrates were coated with the curable compositions by an inkjet method with an inkjet device (MIB-500, manufactured by Musashi Engineering, Inc.) Surfaces of the silicon substrates which had been coated with the curable composition were observed and determined for inkjet coatability according to the below-mentioned criteria.
A: A coated film was formed on the silicon substrate.
B: A coated film was not formed on the silicon substrate.

### <UV Curability>

The curable compositions of Examples 1 to 4 and Comparative Examples 3 to 6 which had formed into coated films by the inkjet device were evaluated for UV curability. First, coated films were formed from the curable compositions on silicon substrates in the same manner as in the evaluation for inkjet coatability. The thus-formed coated films were exposed at an exposure dose of 1000 mJ/cm² using a parallel exposing device under atmospheric pressure in an air atmosphere. However, the coated film formed of the curable composition of Example 1 was exposed at an exposure dose of 500 mJ/cm². The thus-exposed coated films were baked under conditions described in Table 1 or 2 to thereby obtain cured films. Film thicknesses of the resulting cured films are described in Tables 1 and 2. Note that, the cured film formed of the curable composition of Comparative Example 6 was not sufficiently cured, so was not measured for a film thickness. The cured films were touched with a finger and determined for UV curability according to the below-described criteria.
A: There was no tack when the cured film was touched with a finger.
B: There was tack when the cured film was touched with a finger.

### <Storage Stability>

An initial viscosity of the curable composition immediately after preparation as measured by an E-type viscometer at 20° C. and a post-storage viscosity of the curable composition stored for 2 weeks at 20° C. after preparation as measured by an E-type viscometer at 20° C. were measured. An absolute difference between the initial viscosity and the post-storage viscosity was calculated and evaluated for storage stability according to the below-described criteria. A: The absolute difference between the initial viscosity and the post-storage viscosity was 5 cP or less. B: The absolute difference between the initial viscosity and the post-storage viscosity was more than 5 cP.

TABLE 1

| | | Ex. 1 | Ex. 2 | Ex. 3 | Ex. 4 |
|---|---|---|---|---|---|
| Polyfunctional vinyl ether | Type | A1 | A1 | A1 | A1 |
| compound (A) | Part (s) by mass | 90 | 90 | 90 | 90 |
| Other polymerizable | Type | — | — | — | — |
| compounds (A′) | Part (s) by mass | — | — | — | — |
| Polyfunctional thiol | Type | B1 | B1 | B2 | B2 |
| compound (B) | Part (s) by mass | 0 | 10 | 10 | 15 |
| Photoradical initiator (C1) | Type | C1-1 | C1-1 | C1-2 | C1-1 |
| | Part (s) by mass | 3 | 3 | 3 | 3 |
| Photoacid generator (C2) | Type | C2-1 | C2-1 | C2-2 | C2-1 |
| | Part (s) by mass | 3 | 3 | 3 | 3 |
| Photobase generator (C3) | Type | — | — | — | — |
| | Part (s) by mass | — | — | — | — |
| Sensitizing agent (D) | Type | D1 | D1 | D2 | D1 |
| | Part (s) by mass | 1.5 | 1.5 | 1.5 | 1.5 |
| Stabilizing agent (E) | Type | E1 | E1 | E1 | E1 |
| | Part (s) by mass | 4 | 4 | 4 | 4 |
| Other additives | Type | — | — | — | — |
| | Part (s) by mass | — | — | — | — |
| Solubility of curing agent (C) | | A | A | A | A |
| Inkjet coatability | | A | A | A | A |
| UV curability | Exposure dose | 500 | 1000 | 1000 | 1000 |
| | mJ/cm² | | | | |
| | Baking conditions | 1 min at | 1 min at | 1 min at | 1 min at |
| | | 120° C. | 180° C. | 120° C. | 120° C. |
| | Film thickness (nm) | 48.8 | 46.7 | 43.2 | 46.7 |
| | Evaluation | A | A | A | A |

| | | | | |
|---|---|---|---|---|
| Storage stability | A | A | A | A |

TABLE 2

| | | Comp. Ex. | Comp. Ex. | Comp. Ex. | Comp. Ex. | Comp. Ex. | Comp. Ex. |
|---|---|---|---|---|---|---|---|
| | | 1 | 2 | 3 | 4 | 5 | 6 |
| Polyfunctional vinyl ether | Type | — | | A1 | A1 | A1 | A1 |
| compound (A) | Part (s) by mass | | | 90 | 90 | 90 | 50 |
| Other polymerizable | Type | A' 1/A' 2 | A' 1/A' 2 | | | | A' 3 |
| compounds (A') | Part (s) by mass | 37.5/50 | 70/30 | | | | 30 |
| Polyfunctional thiol | Type | B1 | | B1 | B1 | B1 | B1 |
| compound (B) | Part (s) by mass | 12.5 | | 10 | 10 | 10 | 20 |
| Photoradical initiator (C1) | Type | | | C1-1 | C1-1 | C1-1 | C1-1 |
| | Part (s) by mass | | | 3 | 3 | 3 | 3 |
| Photoacid generator (C2) | Type | | C2-3 | C2-4 | C2-4 | C2-4 | C2-4 |
| | Part (s) by mass | | 3 | 3 | 3 | 3 | 3 |
| Photobase generator (C3) | Type | C3-1 | | | | | |
| | Part (s) by mass | 3 | | | | | |
| Sensitizing agent (D) | Type | D3 | D1 | | — | | — |
| | Part (s) by mass | 1 | 0.5 | | | | |
| Stabilizing agent (E) | Type | | | | E1 | E1 | |
| | Part (s) by mass | | | | 1 | 1 | |
| Other additives | Type | | | | | F1 | |
| | Part (s) by mass | | | | | 0.04 | |
| Solubility of curing agent (C) | | A | A | A | A | A | B |
| Inkjet coatability | | B | B | A | A | A | A |
| UV curability | Exposure dose | | | 1000 | 1000 | 1000 | 1000 |
| | mJ/cm² | | | | | | |
| | Baking conditions | | | 3 min at | 5 min at | 5 min at | 5 min at |
| | | | | 120° C. | 150° C. | 150° C. | 180° C. |
| | Film thickness (nm) | | | 15 | 36.6 | 37.2 | |
| | Evaluation | | | A | A | A | B |

| | | | | | | |
|---|---|---|---|---|---|---|
| Storage stability | A | A | B | B | B | B |

It can be seen from Tables 1 and 2 that the curable compositions of Examples including the polyfunctional vinyl ether compound (A), the polyfunctional thiol compound (B), the photoradical initiator agent (C1) and the photoacid generator (C2) serving as the curing agent (C), the carbazole compound serving as the photosensitizing agent (D), and the imidazole compound serving as the stabilizing agent (E) had excellent inkjet coatability, UV curability, and storage stability. On the other hand, the curable compositions of Comparative Examples lacking one of the above-mentioned essential components had at least one of poor inkjet coatability, UV curability, and storage stability.

What is claimed is:

1. A curable composition comprising:
a polyfunctional vinyl ether compound (A);
a polyfunctional thiol compound (B);
a curing agent (C);
a photosensitizing agent (D); and
a stabilizing agent (E),
wherein the curing agent (C) comprises a photoradical initiator (C1) and a photoacid generator (C2),
the photosensitizing agent (D) comprises a carbazole compound, and
the stabilizing agent (E) comprises an imidazole compound.

2. The curable composition according to claim 1, wherein the photoacid generator (C2) comprises a diazomethane compound.

3. The curable composition according to claim 1, comprising or not comprising a solvent (S),
wherein a mass proportion of the solvent (S) to the curable composition is 0% by mass or more and 5% by mass or less.

4. The curable composition according to claim 1, wherein the carbazole compound is carbazole or N-alkyl carbazole.

5. The curable composition according to claim 1, wherein the imidazole compound has one or more radical polymerizable groups.

6. The curable composition according to claim 1, wherein an absolute difference between an initial viscosity of the curable composition immediately after preparation as measured by an E-type viscometer at 20° C. and a post-storage viscosity of the curable composition stored for 2 weeks at 20° C. after preparation as measured by an E-type viscometer at 20° C. is 5 cP or less.

7. A cured product of the curable composition according to claim 1.

8. A method for forming a cured film, the method comprising:
coating a substrate with the curable composition according to claim 1 to form a coated film;
exposing the coated film; and
heating the coated film having been exposed.

9. A method for forming a cured film according to claim 8, wherein the substrate is coated with the curable composition by an inkjet method.
